(19) United States
(12) Patent Application Publication
(10) Pub. No.: US 2005/0008553 A1
(43) Pub. Date: Jan. 13, 2005

(54) Method of loading a radioelement generator with mother radionuclide

(75) Inventors: Christos Apostolidis, Heidelberg (DE); Bruno Brandalise, Linkenheim-Hochstetten (DE); Ramon Carlos-Marquez, Karlsruhe-Durlach (DE); Willem Janssens, Ranco (IT); Roger Molinet, Linkenheim (DE); Tuomo Nikula, Stutensee (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: The European Atomic Energy Community (EURATOM), Brussels (BE)

(21) Appl. No.: 10/847,995

(22) Filed: May 19, 2004

(30) Foreign Application Priority Data
May 22, 2003 (EP) 03 101 480.6

(51) Int. Cl. G21G 4/00

(52) U.S. Cl. 423/2; 250/493.1

(57) ABSTRACT

The invention relates to a method of loading a mother radionuclide into a radionuclide generator which comprises an cation exchange material, the said method comprising a preliminary step which consists in passing over said material a solution containing the mother radionuclide and a complexing agent for said radionuclide, said complexing agent being at an effective concentration so as to prevent the mother radionuclide from concentrating solely in one part of the volume of the cation exchange material, the cation exchange material being chosen in the group consisting of the macroporous resins and the resins having a crosslinking rate of from 1 to 12%. This method is applied to radioisotope generators which emit α particles and are used in particular in the field of radiotherapy.

### TECHNICAL FIELD

The object of the present invention is to provide a method of loading a radionuclide generator with a mother radionuclide, in particular a radionuclide generator where at least one of the radionuclides in cascade emits α particles, such as a ²²⁵Ac/²¹³Bi generator.

The field of the invention may therefore be defined as that of radionuclide generators from which can be eluted α particles emitting radionuclides, the said radionuclides being suitable for use in particular in the field of radioimmunotherapy.

Generally speaking, radioimmunotherapy consists in carrying radioisotopes via transporters such as monoclonal antibodies towards malignant cells or groups of such cells. In the course of their radioactive decay, these radioisotopes release energetic particles which are capable of destroying the malignant cells. In the past, this technique have used radionuclides which during their decay emit β particles.

These particles are long-distance particles (of the order of 1 to 10 mm) which, consequently, have the capacity to destroy a group of cells rather than isolated cells and, consequently, are effective in the treatment of large tumours. In recent years, research also concentrated on radionuclides and radionuclide generators which emit α particles.

The reason for this is that these particles, owing to their short distances (of the order of the diameter of a limited number of cells) and their very high linear energy transfer, are particularly suitable for the targeted destruction of micrometastases or else of isolated malignant cells, as in the case of leukaemia.

Moreover, the cells irradiated by the a particles have a reduced capacity for repairing the damaged DNA, so rendering these particles of great interest for the destruction of isolated malignant cells.

Generally speaking, the production for therapeutic purposes of radionuclides which emit a particles is carried out using generators of such radionuclides.

In the majority of cases, these generators are present in the form of at least one column packed with a material on which a radionuclide, referred to as the mother radionuclide, is absorbed in a loading operation. This mother radionuclide, in the course of its radioactive decay, generates various radionuclides which emit α particles (and are called daughter radionuclides), which are separated from the mother radionuclide during one or more elution steps.

In order to be able to be used for therapeutic purposes, these daughter radioisotopes may be fixed directly, by various techniques, onto monoclonal antibodies or other carriers (biomolecules) which are capable of targeting a group of cells to be treated with the α particles.

By way of examples of daughter radionuclides which are emitters of α particles, mention may be made of ²¹¹At (t_{1/2}=7.2 h), ²¹²Bi (t_{1/2}=60.6 min), ²¹³Bi (t_{1/2}=45.6 min), ²²³Ra (t_{1/2}=11 days) and ²⁵⁵Fm (t_{1/2}=7.2 h).

Greater details concerning the radionuclides which emit α particles are available in the publication by Mirzadeh, “Generator-produced Alpha-emitters”, Appl. Radiat. Isot., Vol. 49, No. 4, pp. 345-349, 1998 [1] and the publication by McDevitt et al., “Radioimmunotherapy with alpha-emitting nuclides”, European Journal of Nuclear Medicine, Vol. 25, No. 9, September 1998, pp. 1341-1351 [2].

Numerous articles in the literature describe α radionuclide generators, especially generators which produce ²¹²Bi and ²¹³Bi (the mother radionuclides being, respectively, ²²⁸Th or ²²⁴Ra and ²²⁵Ac).

Accordingly, the authors Zucchini et al. in “Isotopic Generator for ²¹²Pb and ²¹²Bi”, Int. J. Nucl. Med. Biol., Vol. 9, pages 83-84, 1982 [3], the authors Atcher et al., “An improved Generator for the Production of ²¹²Pb and ²¹²Bi from ²²⁴Ra”, Appl. Radiat. Isot., Vol. 39, No. 4, pp. 283-286, 1988 [4], and the authors Geerlings et al., “The Feasibility of ²²⁵Ac as a source of α-particles in radioimmunotherapy”, Nuclear Medicine Communications (1993), 14, pp. 121-125 [5], describe generators which consist of a column packed with an organic or inorganic material on which the mother radionuclides are absorbed.

However, the drawback of the generators described in the above-mentioned publications is that they are subject to premature degradation of the materials packing the column.

In effect, during the step of loading the column with mother radionuclide, such as ²²⁵Ac, the said nuclide is absorbed primarily, by affinity with the material packing the column, at the top of the said column. Consequently, the material at the top of the column is exposed to intense irradiation owing to the local emission of α particles, so causing it to degrade.

In order to resolve this phenomenon of localized radiolysis, the authors Wu et al. in “An improved Generator for the Production of ²¹³Bi from ²²⁵Ac”, Radiochimica Acta 79, pp. 141-144 (1997) [6] propose distributing the mother radionuclide over the column by means of the following loading method, comprising the following successive steps:

packing a column with a resin having a high affinity for ²²⁵Ac, the said resin being subsequently equilibrated with a nitric acid solution;

withdrawing approximately (⅔) of the resin packing the column, the said withdrawn resin being subsequently transferred to a test tube containing the mother radionuclide ²²⁵Ac and the resulting mixture being incubated at ambient temperature and subjected to vigorous stirring; and

returning the resin impregnated with mother radionuclide to the initial column.

Despite the fact that this loading method, set out above, allows the radionuclide to be distributed over the major part of the column, it has the important drawback of giving rise to contamination of the exterior during its implementation, and is also difficult to realize on a large scale. The method also has a risk to expose the workers to high radiation doses.

Patent Application EP 0967618 A1 [7] likewise describes a method of loading a ²²⁵Ac radionuclide generator, the said method aiming to minimize the phenomenon of localized radiolysis by using a continuous circulation of eluent during the storing step.

More specifically, a continuous eluent circulation of the daughter radionuclide ²¹³Bi is provided over the entire length of the column. This method has the drawback of necessitating the installation of a unit for eluent circulation of the daughter radionuclide during the storing of the generator, thereby ruling out the implementation of this method on a large scale. The circulation also increase actinium-225 breakthrough.

To summarize, the prior art methods of loading a generator with mother radionuclide all feature one or more of the following drawbacks:

they give rise to localized radiolysis of the generator, owing to concentration of the radionuclide at the top of the generator;

they give rise to pollution outside the generator, during the packing of the column;

they are not suitable for large scale application.

The object of the present invention is to provide a method of loading a generator of radionuclides with a mother radionuclide, that allows a homogenous distribution of the said radionuclide in the volume of the generator, and thus allowing the minimisation of the risks of the breakthrough of the mother radionuclide during the elution steps.

This object is achieved by means of a method of loading a mother radionuclide into a radionuclide generator which comprises a cation exchange material, the said method comprising a preliminary step which consists in passing over the said material a solution containing the mother radionuclide and a complexing agent for the said mother radionuclide, the said complexing agent being at an effective concentration such as to prevent the mother radionuclide from concentrating solely in one part of the volume of the cation exchange material, the cation exchange material being chosen in the group consisting of the macroporous resins and the resins having a crosslinking rate of 1% to 12%.

Advantageously, the passing of a solution comprising the mother radionuclide and a complexing agent for the said radionuclide thus makes it possible to obtain a distribution of the radionuclide (in complexed form) over the optimal volume of cation exchange material. The reason for this is that the complex formed by the radionuclide and its complexing agent exhibits the capacity to be fixed to the cation exchange material to a lesser extent than the weakly or uncomplexed radionuclide. Consequently, the mother radionuclide thus complexed no longer has a tendency to concentrate in any given part of the material. There is therefore a difference between this and the prior art embodiments where the generator was packed with a mother radionuclide by passing in a solution containing solely the mother radionuclide in the environment, where required amount and type of the mother radionuclide—complexing agent complex is not present.

In the embodiments of the prior art, the mother radionuclide, owing to its strong affinity with the material constituting the generator, became concentrated at the site where the solution was introduced, and contributed to the deterioration of the generator at the site of its concentration, owing to an intense radiative emission generated by the radioactive decay of the mother radionuclide.

Furthermore, the authors have discovered that, by using a cation exchange material as mentioned above, i.e. macroporous resins and resins having a crosslinking rate of 1% to 12%, the both having a high exclusion limit, it is possible to get better distribution of the mother radionuclide over column without significant decrease of amount of the daughter radionuclide(s) in the eluent.

The said resins may be, for example, a styrene-divinylbenzene or styrene-acrylic acid copolymer with exchanger groups such as SO₃⁻ groups.

The exclusion limit of a support is defined by the size of the largest molecule able to enter the pores under a given set of conditions. Typically, for ion-exchange resins whose crosslinking rate decreases from 12% to 1%, the exclusion limit increases from roughly 400 to 3500. Resins with the higher exclusion limits are considered to be macroporous resins.

Several companies are producing this type of resins with different trade names for example Bio-Rad has at least following resins which can be suitable to this application:

AG50W resin (available with different crosslinking rates)

AG MP50 resin (macroporous resin).

The selection of the complexing agent effective for meeting the conditions would of course be made as a function of the mother radionuclide which is incorporated into the generator. The effective concentration of a considered complexing agent would be made as a function of the resin used in the generator.

Some examples of complexing agents can be acetate ion, Cl⁻ (other halogen ions are also suitable), NO₃⁻.

Once the complexing agent has been selected as a function of the nature of the radionuclide, this complexing agent, for a given cation exchange material, must be present in the solution at a concentration which is effective to prevent an immediate binding of the radionuclide to the cation exchange material resulting in a concentration of the said radionuclide at a specific site in the material. In other words, the concentration of the complexing agent is chosen in such a way that the complexation reaction is in competition with the absorption reaction, thereby keeping at least part of the mother radionuclide in the solution. The distribution of the mother radionuclide between the solution and the cation exchange material may be expressed as distribution coefficient, which corresponds to the following ratio:

(concentration of mother radionuclide over the material)/(total mother radionuclide concentration).

The concentration of the complexing agent may easily be determined by the person skilled in the art in the course of experiments. For example, the selection of an effective concentration may be made by determining, for solutions at different concentrations, the radioactivity which is not bound on the cation exchange material (the activity being expressed as a percentage of total activity).

In practice, this coefficient is determined by batch experiments as follows:

the cation exchange material is mixed with a solution containing the mother radionuclide and a complexing agent for the said radionuclide;

the mixture is incubated and then centrifuged;

the concentration of the radionuclide in the material is determined by various techniques, such as gamma spectroscopy, and then the ratio of the concentration of radionuclide on the cation-exchange material to the total radionuclide concentration is calculated (this concentration being known from the start).

Preferably, the complexing agent should be at a concentration which is effective to give a distribution coefficient K_{D} between the solution and the cation exchange material from 0.5 to 0.99, preferably from 0.7 to 0.98.

The method of loading, according to the present invention, may further comprise at least one step of washing, which consists, after the preliminary step mentioned above, in passing over the cation exchange material a solution containing at least one complexing agent for the mother radionuclide. This step thus makes it possible to improve still further the distribution of the mother radionuclide over the cation exchange material. Note that the complexing agent used for washing may be identical to or different from that used during the preliminary step of the method of the invention. This washing solution has advantageously a significantly lower concentration of complexing agent than the solution which is used in the preliminary step or other substances to prevent hydrolysis of the metal ion, in order to prevent the phenomenon of breakthrough of the radionuclide during washing.

The method of loading, according to the invention, may advantageously comprise, after the preliminary step or the optional washing steps, at least one step which consists in passing over the said cation exchange material a solution containing an agent capable of destroying the complex formed between the mother radionuclide and its complexing agent.

In other words, when the mother radionuclide has been distributed in the form of a complex over the optimised part of the volume of the material, by virtue of the preliminary step of the method and of the optional washing steps, the complexed radionuclide may advantageously undergo decomplexation. When thus decomplexed, the mother radionuclide becomes strongly fixed to the cation exchange material, thereby preventing this radionuclide undergoing breakthrough during the steps of elution of the daughter radionuclides.

The decomplexation agent may be any substance which effectively destroys the complex between radionuclide and complex agent including, for example, an effective concentration of original complexing agent allowing the radionuclide to be retained on the cation exchange material.

As a decomplexing solution it is possible for example to use a solution containing a minimal amount or concentration of a complexing agent (identical to or different from that used during the preliminary step) to allow to break down the complex between metal ion and a complexing agent which was used in the course of the preliminary step, this minimal amount being determined by a man skilled in the art. Consequently, the simple fact of adding a small quantity of this new complexing agent to the solution to be passed over the material will contribute to destroying the complex formed during the preliminary step of the method. The radionuclide thus liberated is absorbed directly on the cation exchange material, owing to the fact that it has an even higher affinity for the cation exchange material of the generator than for the complexing agent of the decomplexing solution.

Explicitly, this phenomenon of decomplexation may be illustrated by the following reactions:

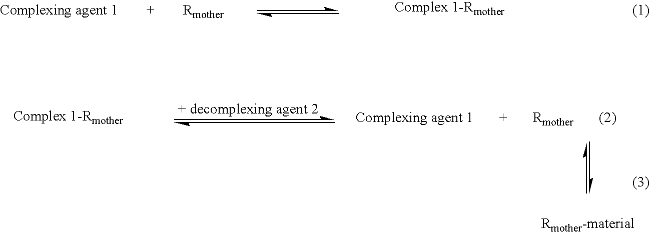

Complex 1-Rₘₒₜₕₑᵣ: complex formed between Complexing agent 1 and Rₘₒₜₕₑᵣ used during the preliminary step of the method;

Rₘₒₜₕₑᵣ: mother radionuclide;

Decomplexing agent 2: substance used to destroy Complex 1-Rₘₒₜₕₑᵣ;

Material: cation exchange material which makes up the generator.

Equation (1) illustrates the complexation equilibrium which exists in the solution employed in the course of the preliminary step of the method, this equilibrium being largely shifted in the direction of formation of the complex.

Equation (2) illustrates the equilibrium during decomplexation shifting to right in the course of the decomplexation. Once decomplexed, the mother radionuclide is absorbed on the material, see Equation (3), owing to the fact that the forces of attraction of the material are greater than the forces of complexation of the decomplexing agent 2.

The method of loading, according to the present invention, may be applied to any type of radioelement generator, especially radioelement generators which emit α particles.

This method therefore most particularly finds application for the loading of generators in which the mother radionuclide is ²²⁵Ac, this mother radionuclide producing, during its radioactive decay, several daughter radionuclides which are emitting α particles.

In the case of a radionuclide generator whose mother radionuclide is ²²⁵Ac, the cation exchange material of the generator may be a macroporous resin containing —SO₃⁻ groups as exchanger groups. This material may in particular be a resin based on styrene and divinylbenzene, bearing —SO₃⁻ ionic groups.

A particularly effective complexing agent for ²²⁵Ac may preferably be selected from nitric acid, hydrochloric acid and mixtures thereof.

In particular, when the complexing agent selected to complex ²²⁵Ac is nitric acid, particularly when the cation exchange material is a resin based on styrene-divinylbenzene bearing —SO₃⁻ group, it may advantageously be used, in the solution containing ²²⁵Ac and the said complexing agent, at concentrations greater than or equal to 1.5 mol.l⁻¹, preferably from 2 to 2.5 mol.l⁻¹, when using highly crosslinked resins such as resins having a crosslinking rate over 5 to 8% (higher concentrations are useful when using less crosslinked materials) and preferably from 5 to 7.5 mol.l⁻¹ when using macroporous resins.

The optional washing step to get a more uniform distribution may be effected by passing through the cation exchange material a solution of nitric acid at the same as or lower concentration than the concentration used in the preliminary step.

When the complexing agent is HNO₃, said decomplexation, being intended to fix ²²⁵Ac on the column and to minimize the phenomenon of breakthrough of the ²²⁵Ac outside the column, may advantageously be carried out by passing through the cation exchange material at least once a solution of hydrochloric acid having, for example, a concentration of from 0.001 to 0.01 mol.l⁻¹.

When the complexing agent is HNO₃, the said decomplexation, being intended to fix ²²⁵Ac on the column and to minimize the phenomenon of breakthrough of the ²²⁵Ac outside the column, may advantageously be carried out by passing through the cation exchange material at least once a solution of nitric acid having, for example, a concentration of from 0.001 to 0.01 mol.l⁻¹.

As the complexing agent for the actinium-225 it is also possible to use hydrochloric acid, which may be used advantageously, in the solution containing ²²⁵Ac, at concentrations of more than 2 mol.l⁻¹, preferably from 2.5 to 3.5 mol.l⁻¹ when using highly crosslinked resins, such as resins having a crosslinking rate over 5 to 8% (higher concentrations are useful when using less crosslinked materials).

The optional washing step to get a more uniform distribution may be effected by passing through resin a solution of hydrochloric acid at the same or lower concentration than the concentration used in the preliminary step.

In detail, the method of loading a generator with mother radionuclide ²²⁵Ac may be carried out in the manner which is set out hereinbelow.

Thus, a solution containing the mother radionuclide and its complexing agent is passed through the cation exchange material which makes up the column (by simple gravity or peristaltic pump or any method which allows the solution to pass through the column).

Note that prior to the method of loading with actinium-225, the generator is generally prepared by packing a column, for example, in glass, polyethylene (or any other suitable material) tube with the required supporting material to hold resin in the tube with an appropriate cation exchange material. Once prepared, this column, before the passage of the solution containing the mother radionuclide and its complexing agent, may be equilibrated by passing over the cation exchange material a solution containing solely the complexing agent without the mother radionuclide.

In order to improve the distribution of the mother radionuclide over the cation exchange material, the loading method may include one or more steps of washing the material with a solution containing solely the complexing agent present in the solution containing the radionuclide or optionally containing another complexing agent for the radionuclide.

Finally, in order to minimize breakthrough, the loading method of the present invention may comprise a step of decomplexing the said mother radionuclide, the said step consisting in passing over the cation exchange material a solution containing an agent capable of liberating the mother radionuclide from its complexed form. On account of the high affinity of the cation exchange material for the mother radionuclide in decomplexed form, the radionuclide thus decomplexed is instantaneously fixed to the cation exchange material of the generator.

Note that, once the loading method according to the invention has been implemented, it is followed conventionally by one or more steps of elution which are aimed at the daughter radionuclide or radionuclides. When the daughter radionuclides have been recovered in an elution solution, the said solution may be used, in the course of a subsequent step, for the labelling of antibodies, monoclonal antibodies for example, or other biomolecules with a view to transporting the said radionuclides to specific sites. The invention therefore finds its application in the field of radio(immuno)therapy.

The invention will now be described in more detail with reference to the examples which are set out hereinbelow.

### BRIEF DESCRIPTION OF THE DRAWINGS

FIG. 1: view of a generator loaded according to a prior art process;

FIG. 2: view of a generator loaded according to a preferred embodiment of the present process.

### DETAILED DESCRIPTION OF THE INVENTION

The examples which follow illustrate the efficiency of the inventive ²²⁵Ac loading method, particularly using different cation exchange materials with different ²²⁵Ac-complexing agents at different concentrations.

For each of the examples set out below, the actinium-225 is obtained from a ²²⁹Th source and is purified to remove any ²²⁵Ra contamination.

Greater details relating to obtaining a pure solution of ²²⁵Ac are available in the publication by Apostolidis et al., “Production of carrier-free actinium-225/bismuth-213 from thorium-229 for alpha-immunotherapy”, J. Labelled Cpd.Radiopharm.44, Suppl. 1 pp. 806-808 [8]. When the pure actinium-225 solution has been obtained, this solution is evaporated to dryness and the residue is subsequently dissolved in a small volume of an acidic solution, which is the same solution that this used to complex the mother radionuclide.

The generators which are used in the context of these examples are in the form of a column of plastic material made of polyethylene (PE). The column, before loading of the mother radionuclide, is packed with a cation exchange material, to give an ion exchange column measuring 0.4*4 cm (diameter*height) and having a total volume of 0.5 ml. This column is subsequently equilibrated by passing through the said column a solution containing solely a complexing agent for the mother radionuclide.

The pure solution of actinium-225 is subsequently diluted by adding a volume of complexing agent solution, the said volume being equivalent to twice that of the column prepared above.

The generators are subsequently loaded with this solution.

In order to homogenize the actinium distribution, in each of the experiments washing is carried out using a solution containing solely the complexing agent with the same concentration as the initial loading solution, the said washing solution having a volume equivalent to 6 times that of the column (approximately 3 ml).

### EXAMPLE 1

In this example, the cation exchange material used is a macroporous resin (AGMP 50 BIORAD) exclusion limit >1,000,000 based on styrene and divinylbenzene which contains ionic groups of —SO₃⁻ type. The particle size was 100-200 mesh (75-150 micrometer)

The column is loaded with ²²⁵Ac by passing through the said column, in the course of a preliminary step, a solution containing ²²⁵Ac 1 mCi (37 MBq) and nitric acid at different concentrations (from 4 to 10 mol.l⁻¹), this solution having a volume corresponding to twice the volume of the column.

For this example, the process of loading with actinium-225 also comprises washing with six bed volumes with the same nitric acid concentration, which has been used during the initial loading. The decomplexation step comprises washing with two bed volumes of 0.005 M HNO₃. To convert column from nitrate form to chloride form, the generator was washed with 1 ml of 2 M HCl. Finally the column was stabilised with 0.001-0.01 M HCl.

In order to demonstrate the efficiency of the loading method according to the invention, measurements were made, at different sites in the column, of the % radioactivity released at these sites, relative to the total activity (the measurement of the activity corresponding to an indirect measurement of the distribution of actinium in the column).

The results are given in Table 1 below:

TABLE 1

| Site in | | | | | | | | | |
|---|---|---|---|---|---|---|---|---|---|
| column | | | | | | | | | |
| (top to | HNO₃ | HNO₃ | HNO₃ | HNO₃ | HNO₃ | HNO₃ | HNO₃ | HNO₃ | HNO₃ |
| bottom) | 4 M | 5 M | 6 M | 6.5 M | 7 M | 7.5 M | 8 M | 9 M | 10 M |
| 1^{st} | 100 | 99 | 82 | 29 | 23 | 15 | 11 | 4 | 4 |
| quarter | | | | | | | | | |
| 2^{nd} | — | 1 | 19 | 60 | 66 | 64 | 34 | 20 | 23 |
| quarter | | | | | | | | | |
| 3^{rd} | — | — | — | 11 | 11 | 17 | 47 | 50 | 42 |
| quarter | | | | | | | | | |
| 4^{th} | — | — | — | — | — | 4 | 7 | 22 | 25 |
| quarter | | | | | | | | | |

“1^{st} quarter”, “2^{nd} quarter”, and so on means the 1^{st}, 2^{nd}, etc. quarter of volume starting from the top of the column, in other words the zone where the solutions are introduced and the Ac-225 distributed.

In this example, therefore, the distribution which is observed of the actinium-225 over the volume of the column is entirely satisfactory (in other words, an actinium distribution which extends over an optimal of the volume of the column and no longer at the top of the column as is the case for the loading embodiments of the prior art) for nitric acid concentrations from 6 to 10 mol.l⁻¹. The most optimal concentration is 6.5 to 7 mol.l⁻¹.

### EXAMPLE 2

In this example, the procedure followed in Example 1 is repeated but using, as cation exchange material, a highly cationic resin based on styrene and divinylbenzene with 8% crosslinking (Dowex 50 W×8, FLUKA). The particle size was 100-200 mesh (75-150 micrometer), containing —SO₃⁻ groups as ionic groups, and a HNO₃ complexing solution having concentrations of from 1.0 to 3 mol.l⁻¹. For this example, the process of loading with actinium-225 also comprises washing with six bed volumes with the same nitric acid concentration, which has been used during the initial loading. The decomplexation step comprises washing with two bed volumes of 0.005 M HNO₃. To convert column from nitrate form to chloride form the generator was washed with 2 M HCl. Finally the column was stabilised with 0.001-0.01 M HCl.

The results are given in Table 2 below.

TABLE 2

| | HNO₃ | HNO₃ | HNO₃ | HNO₃ | HNO₃ |
|---|---|---|---|---|---|
| | 1.0 M | 1.5 M | 2 M | 2.5 M | 3 M |
| 1^{st} quart. | 95 | 70 | 17 | 14 | <1 |
| 2^{nd} quart. | 5 | 30 | 78 | 75 | 3 |
| 3^{rd} quart. | | — | 5 | 11 | 45 |
| 4^{th} quart. | | — | — | — | 35 |

Thus by using the type of resin specified above a satisfactory distribution of the actinium is obtained starting from 2 M nitric acid solution.

### EXAMPLE 3

In this example, the procedure followed in Example 1 is repeated but using, as cation exchange material, a highly cationic resin based on styrene and divinylbenzene (8% crosslinked) containing —SO₃⁻ groups as ionic groups, the particle size was 100-200 mesh (75-150 micrometer) (AGMP50, BIORAD) and an HCl complexing agent solution having concentrations of from 2 to 4 M.

The results are given in Table 3 below.

TABLE 3

| | HCl 2M | HCl 3M | HCl 4M |
|---|---|---|---|
| 1^{st} quart. | 100 | 5 | 1 |
| 2^{nd} quart. | — | 68 | 15 |
| 3^{rd} quart. | — | 27 | 53 |
| 4^{th} quart. | — | — | 28 |

Thus by using the type of resin specified above a satisfactory distribution of the actinium is obtained from 2.5-3.5 M hydrochloric acid solution.

### EXAMPLE 4

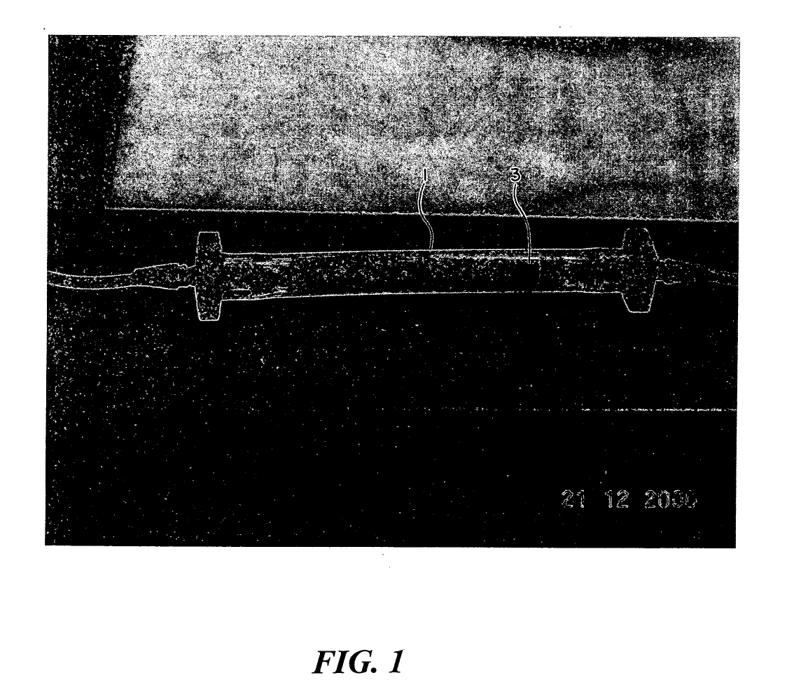

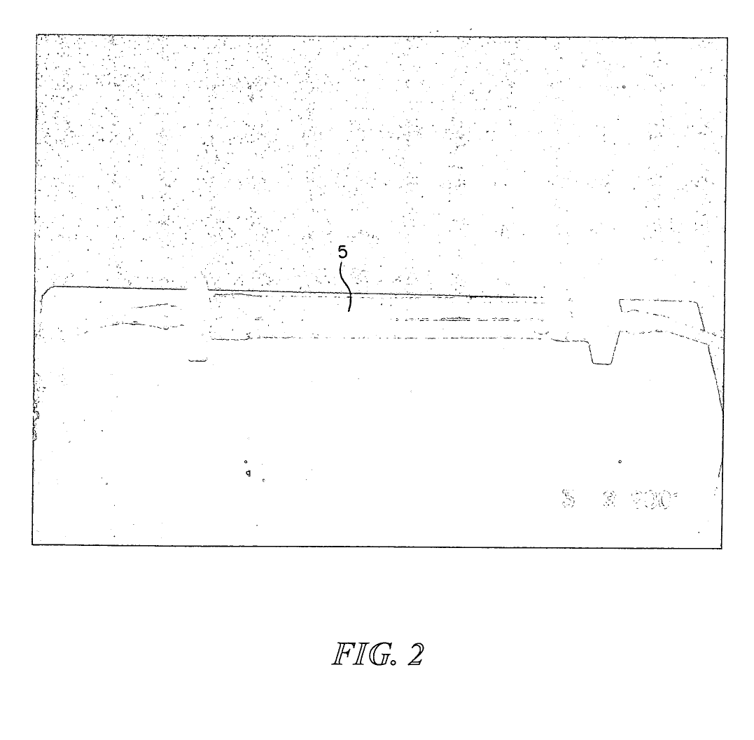

Two generators were loaded using a macroporous resin (matrix: styrene divinylbenzene, the functional group: R—SO₃⁻) (AGMP50, BIORAD) the particle size was 100-200 mesh (75-150 micrometer) with 25 mCi actinium-225. The first one (generator referenced 1 in FIG. 1) was loaded using 2 M HCl as complexing agent. (Compare example 3: 2M HCl) (Geerlings et al., 1993, “The feasibility of ²²⁵Ac as a source of a-particles in radioimmunotherapy” Nucl Med Commun 14, 121-125). The second one (generator referenced 5 in FIG. 2) was loaded using 6,5 M HNO₃ as complex form agent. The elution yield, flow, ²²⁵Ac-breakthrough, labelling efficiency and visible changes of the matrix were recorded over 1 month period.

The elution yield of the generator A was during very first days approximately 90% from the theoretical maximum yield. After one week use the elution yield was decreased under 50% and remarkable higher pressure was required to push elution solution through the column. Simultaneously, labelling efficiency was reduced down 40 to 60%. After two weeks period the column was almost blocked and the elution yield was poor.

The elution yield of the generator B was approximately 90% from the theoretical maximum yield over one month. No changes in the flow were observed. The labelling efficiency was approximately the same (70%) over one month and no actinium-225 contamination was observed in the final product.

Both generators were photographed after one month (Generator A: FIG. 1 and Generator B: FIG. 2. The arrows in the figures are indicating flow-direction). In the FIG. 1 (generator A) the strong black band (reference 3) on the top of the column is caused by strong local radiation. Otherwise in the FIG. 2 (generator) radiolysis damages are much less visible and they are well distributed over whole first half top part of the generator.

1. Method of loading a mother radionuclide into a radionuclide generator which comprises a cation exchange material, said method comprising a preliminary step which consists in passing over said material a solution containing the mother radionuclide and a complexing agent for said radionuclide, said complexing agent being at an effective concentration such as to prevent the mother radionuclide from concentrating solely in one part of the volume of the cation exchange material, the cation exchange material being chosen in the group consisting of macroporous resins and resins having a crosslinking rate of from 1 to 12%.

2. Method according to claim 1, wherein the complexing agent is at a concentration giving a distribution coefficient K_{D} of said mother radionuclide between the solution and the cation exchange material from 0.5 to 0.99.

3. Method according to claim 2, wherein K_{D} is from 0.7 to 0.98.

4. Method according to claim 1, further comprising at least one step of washing, which consists, after the preliminary step, in passing over the cation exchange material a solution containing at least one complexing agent for said mother radionuclide.

5. Method according to claim 4, further comprising, after the preliminary step or the washing step(s) at least one step consisting in passing over the said cation exchange material a solution containing a decomplexing agent capable of destroying the complex formed between the mother radionuclide and the complexing agent.

6. Method according to claim 1, further comprising, after the preliminary step at least one step consisting in passing over the said cation exchange material a solution containing a decomplexing agent capable of destroying the complex formed between the mother radionuclide and the complexing agent.

7. Method according to claim 1, wherein the mother radionuclide is ²²⁵Ac.

8. Method according to claim 7, wherein the cation exchange material is a macroporous resin based on styrene and divinylbenzene bearing —SO₃⁻ ionic groups.

9. Method according to claim 7, wherein the complexing agent is selected from nitric acid, hydrochloric acid and mixtures thereof.

10. Method according to claim 9, wherein the complexing agent is nitric acid.

11. Method according to claim 10, wherein the nitric acid has a concentration greater than or equal to 1.5 M.

12. Method according to claim 11, wherein the nitric acid has a concentration of from 5 to 7.5 M and the resin is a macroporous resin.
